(19) United States
(12) Patent Application Publication
(10) Pub. No.: US 2013/0318006 A1
(43) Pub. Date: Nov. 28, 2013

(54) ROLLING SETTLEMENT FOR TRI PARTY TRANSACTIONS

(71) Applicant: THE BANK OF NEW YORK MELLON, New York, NY (US)

(72) Inventors: John Morik, Old Bridge, NJ (US); Charles V. Austin, Stamford, CT (US); Erika Lunceford, Brooklyn, NY (US); Brian Blank, Manalapan, NJ (US)

(73) Assignee: THE BANK OF NEW YORK MELLON, New York, NY (US)

(21) Appl. No.: 13/894,991

(22) Filed: May 15, 2013

Related U.S. Application Data
(60) Provisional application No. 61/647,346, filed on May 15, 2012.

(51) Int. Cl. G06Q 40/06

(52) U.S. Cl. CPC G06Q 40/06
USPC 705/36 R

(57) ABSTRACT

A system for settling trades in Tri-Party repurchasing agreements includes one or more processors configured to execute one or more computer program modules. The computer program modules are configured to obtain, on electronic storage media accessible to the one or more processors, security information associated with a plurality of securities securitizing a Tri-Party repurchasing agreement between a dealer and an investor. The computer program modules are also configured to execute one or more computer program modules configured to receive a cash amount from the dealer, the cash amount being less than required to repurchase an entirety of the plurality of securities. The computer program modules are further configured to execute one or more computer program modules configured to release a subset of the entirety of securities to the dealer, the subset of the entirety of securities being repurchased by the cash amount received from the dealer.

This application claims the benefit of U.S. Provisional Patent Application Ser. No. 61/647,346, filed May 15, 2012. This application is also related to U.S. Provisional Patent Application Ser. No. 61/745,187, filed Dec. 21, 2012, and U.S. patent application Ser. No. 13/362,980, filed Jan. 31, 2012. Each of the above mentioned applications are incorporated herein in their entireties by reference.

### BACKGROUND

This application is directed to a computer-implemented system and method associated with Repurchase Agreements (“Repos”). In particular, this application is directed to a computerized system and method for efficiently settling trades by a third party agent (a “Tri-Party agent”) in Tri-Party Repos.

In a Repo, a seller (also known as a dealer/borrower/cash receiver) sells securities for cash to a buyer (also known as an investor/lender/cash provider) and agrees to repurchase those securities at a later date for more cash. The Repo rate is the difference between borrowed and paid back cash expressed as a percentage. The buyer typically utilizes Repos to invest cash for an agreed upon duration of time (typically overnight, although the term may vary), and would receive a rate of interest in return for the investment. The seller typically utilizes Repos to finance long positions in securities or other assets in the seller's portfolio.

Repos are financial instruments used in money markets and capital markets, and are economically similar to a secured loan, with the buyer receiving securities as collateral to protect against default. Virtually any security may be employed in a Repo, including, for example, Treasury or Government bills, corporate and Treasury/Government bonds, stocks/shares, or other securities or financial instruments. In a Repo, however, the legal title to the securities clearly passes from the seller to the buyer, or “investor”. Coupons (installment payments that are payable to the owner of the securities), which are paid while the Repo buyer owns the securities are, in fact, usually passed directly onto the Repo seller. This may seem counterintuitive, as the ownership of the collateral technically rests with the buyer during the Repo agreement. It is possible to instead pass on the coupon by altering the cash paid at the end of the agreement, though this is more typical of Sell/Buy Backs.

Although the underlying nature of a Repo transaction is that of a loan, the terminology differs from that used when talking of loans because the seller does actually repurchase the legal ownership of the securities from the buyer at the end of the agreement. Although the actual effect of the whole transaction is identical to a cash loan, in using the “repurchase” terminology, the emphasis is placed upon the current legal ownership of the collateral securities by the respective parties.

In a Tri-Party Repo, the collateral is managed by a Tri-Party agent (typically a bank), who may match the details of the trade agreed upon by the buyer and the seller, and assume all of the post trade processing and settlement work (e.g., acting as a clearinghouse). The Tri-Party agent controls the movement of securities, such that the buyers do not actually take delivery of collateralized securities. The Tri-Party agent acts as a custodian for the collateral, and allows the flow of collateral and cash between buyers and sellers across one or more deals.

In some Repo agreements, the seller/dealer may have numerous assets that are being managed by the Tri-Party agent. In these cases, it may be desirable for the Tri-Party agent to allow for the restructuring of the collateral of the deals, so that the seller may free up some assets while placing other agreeable assets in the legal ownership of the buyer, during the deal. Such movements would generally be agreed to by the buyer and the seller when entering the agreement to be managed by the Tri-Party agent.

The clearinghouse (e.g., the Tri-Party agent in some embodiments) may provide liquidity to dealers, who borrow funds from the clearinghouse to unwind maturing deals and obtain funds from new investors to pay back the clearinghouse. Currently, this process involves a large credit component, such as an intraday credit, that a clearinghouse injects into the system to unwind deals of the day. For example, at the maturity time in the industry (e.g., at 3:30 in the afternoon), trades are matured, or unwound. At that time, a subset of all the tri-party trades mature. For a deal to mature, the dealer of the trade pays the investor. Specifically, on the maturity date, the dealers pay off or repurchase the securities for the maturing deals. The maturing parties quite often have in new deals that are put out. The clearinghouse generally provides cash to the investors and thus may pay the investors on behalf of the dealer and debit the dealers' accounts en masse. Thus, every maturing trade gets paid all at the same time at the maturity time (e.g., 3:30 in the afternoon). The clearinghouse then returns the collateral, such as securities, from the investor back to the dealer's account.

For some time after the maturity time (e.g., between the hours of 3:30 and 6:30) the dealer prepares and instructs the clearinghouse regarding new tri-party transactions with the same or new investors. The dealers thus move the collateral, such as those returned from the maturing deals, to new investors, and receive cash upon approval from the clearinghouse that all the cash is satisfactory for the deal, and that all the securities are satisfactory for the deal. The clearinghouse has a lien on the collateral in the dealer's account until the dealer repays the clearinghouse.

After the clearinghouse finalizes settlements on all the transactions (e.g., in the evening), the funds from the new investors are used to pay back to the clearinghouse en masse. The dealer thus effectively pays off the loan to the clearinghouse (which paid the maturing deals on behalf of the dealers) and the clearinghouse releases the securities for the new investors.

Because there is a chance the dealer will be unable to pay back the clearinghouse, the unwinding process exposes the clearinghouse to risk in the period between unwinding of existing trades and reallocation and settlement of new trades. Reallocation and settlement of the new trades extinguishes the exposure to independent events, however presently a time gap of exposure occurs in the minutes or up to several hours before the new trades settle.

### SUMMARY

Various embodiments of this disclosure may be used in conjunction with existing financial services platforms, for example the Bank of New York Mellon's Tri-Party repurchase agreement products (RepoEdge®) which allow clients to outsource the operational aspects of their collateralized transactions, and Derivatives Margin Management (DM Edge®), which helps clients manage credit risks associated with derivatives transactions by enabling them to accept, monitor and re-transfer collateral. These services, among others such as Repo Margin Management (RM Edge®), MarginDirect^{SM}, and Derivatives Collateral Net (DCN), may be delivered to clients through AccessEdge^{SM}, a real-time, web-based portal.

The operator/manager of the system and method of this disclosure may act as a third-party service provider to the two principals to a trade, and the various functions performed by the system and method provide value-added services which mitigate risk and lead to greater efficiencies for both parties.

According to an embodiment, a system for settling trades in Tri-Party repurchasing agreements includes one or more processors configured to execute one or more computer program modules. The one or more computer program modules are configured to obtain, on electronic storage media accessible to the one or more processors, security information associated with a plurality of securities securitizing a Tri-Party repurchasing agreement between a dealer and an investor. The one or more computer program modules are also configured to execute, on the one or more processors of the computer system, one or more computer program modules configured to receive a cash amount from the dealer, the cash amount being less than required to repurchase an entirety of the plurality of securities. The one or more computer program modules are further configured to execute, on the one or more processors of the computer system, one or more computer program modules configured to release a subset of the entirety of securities to the dealer, the subset of the entirety of securities being repurchased by the cash amount received from the dealer.

According to another embodiment a computer-implemented method of settling trades in Tri-Party repurchasing agreements, implemented in a computer system comprising one or more processors configured to execute one or more computer program modules, includes obtaining, on electronic storage media accessible to the one or more processors security information associated with a plurality of securities securitizing Tri-Party repurchasing agreements between one or more dealers and one or more investor. The method also includes executing, on the one or more processors of the computer system, one or more computer program modules configured to receive a cash amount from a dealer, the cash amount being less than required to repurchase an entirety of securities associated with a Tri-Party repurchasing agreement between the dealer and an investor. The method further includes executing, on the one or more processors of the computer system, one or more computer program modules configured to release a subset of the entirety of securities to the dealer, the subset of the entirety of securities being repurchased by the cash amount received from the dealer.

The system and method of this disclosure provides various capabilities as discussed more fully in the detailed description below.

### BRIEF DISCUSSION OF THE DRAWINGS

FIG. 1 illustrates an example of maturing Tri-Party Repurchasing trades configured for matching with new proposed deals;

FIG. 2 illustrates how the matching of maturing trades and new proposed deals may impact the settlements;

FIG. 3 illustrates a logic flowchart that implements collateral allocations according to an embodiment of this disclosure;

FIG. 4 illustrates a schematic of a computer system configured to implement the processes described herein; and

FIG. 5 illustrates a schematic of a network interface and program modules associated with performing the processes described herein.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Disclosed herein are a method, apparatus, and system configured to incrementally unwind and settle Tri-Party transactions, reducing risk to tri-party entities such as a clearinghouse. Specifically, an RVP/DVP model is presented that, instead of moving the securities en masse with a large gap in time, relies on smaller, individual movements of securities versus cash. As described in greater detail below, RVP, or Receive vs. Payment, refers to a maturing deal or a principal decrease deal, in which cash is to be settled from the dealer to the investor in exchange for collateral held by the custodian (e.g., the clearinghouse) to be returned back to the dealer. DVP, or Delivery vs. Payment, refers to a new deal or a principal increase deal, in which cash is to be settled from the investor to the dealer in exchange for collateral from the dealer to be held by the custodian.

As described in greater detail below, on maturity day for a repurchase agreement involving a plurality of securities, the clearinghouse utilizes individual movements of the securities versus cash over time, instead of gross movements of paying the associated investor(s) en masse. The clearinghouse may provide liquidity for that smaller, individual movement, such as by identifying the movement of the individual securities by CUSIP code. Upon the movement, the dealer can immediately use the returned collateral and move it to a new investor for cash, and pay back the clearinghouse.

These individual movements may unwind the maturing deals throughout the day in an incremental manner, rather than at one time in one gross movement. While individual movements may create some incremental exposure, the exposure may be extinguished shortly thereafter when the dealer delivers the securities to a new investor, and new cash is received. In one embodiment, the incremental movement may feature a simultaneous or substantially simultaneous exchange of cash and collateral (e.g., security). For example, in an embodiment a server or other computing apparatus of the clearinghouse may electronically deliver a collateral unit (e.g., a security) to a new investor and obtain cash or other monetary value from the investor milliseconds or seconds after the clearinghouse bank obtained the collateral from a maturing deal. In one embodiment, the server or other computing apparatus of the clearinghouse may electronically deliver the collateral and obtain cash from the new investor minutes or hours after obtaining the collateral from a maturing deal. The incremental movements may thus relieve the need for massive amounts of liquidity from a clearinghouse bank.

As an example, the clearinghouse may provide liquidity to the dealer in the amount of 40 units, they may buy 40 units from a maturing deal, sell 40 units to a new investor and immediately pay off the loan to the clearinghouse. In another example, the clearinghouse may lend 10 units, and the dealer buys 10 units, sells 10 units, then borrows 15 units, buys 15 units, and sells 15 units, etc. It may be appreciated that the amount of lending may be capped in some embodiments. In some cases dealer might buy 20 units, then buy another 20 and reach their maximum. As such, the dealer might deliver to a new investor before they can do another receive.

In an example for a maturing deal, on a given maturity day, in the morning the investor may have all securities sitting in their account. Instead of receiving a bulk payment of cash at a certain maturity time (e.g., 3:30) and returning all securities at that time, the investor may receive cash in their account incrementally throughout the business day. In an embodiment the amount of cash may increase as the day progresses. In an embodiment, the cash will begin to be received from the clearinghouse starting at the maturity time (e.g., starting at 3:30), and the securities in the account may incrementally decrease as the dealer buys back all the collateral from the investor. Eventually the dealer may repurchase all the securities from the investor, and the investor will have all the cash and have it available to be wired. The same thing with the new investors.

Rather than have all the cash moved from the investor's account en masse at a given time (e.g., 6:30), the investor's cash account may slowly decrease as their securities slowly increase. The dealer may deliver securities incrementally until all cash in the investor's cash account decreases towards zero, and new investors have all securities in the account to settle the trade. Accordingly, in an embodiment at the end of the maturity day, the maturing investor has all their cash to get paid, while the new investor has all securities, and have given up their cash.

In an embodiment, the receiving and delivering of securities can be optimized to match available securities, such as from maturing deals, with investment profiles of the new investors. In an embodiment, optimal placement of the securities can be determined automatically, or through dealer/investor preference. For example, each dealer or investor might have their own optimization criteria. So an optimization algorithm may determine that security A from maturing deal best matches a new investor. The optimization may be based on investment profiles. The optimizer, which may be implemented through one or more processors executing instructions on a non-transitory computer readable medium, may instruct movements by the clearinghouse. For example, the optimizer may instruct the system to receive and deliver the collateral on a CUSIP by CUSIP basis, where the security should end up in the best possible fit for that dealer. The optimizer may be configured to examine the new deals, and analyze the eligibility and the collateral eligibility of all those deals, and compares the eligibility of the deals to the collateral on hand for the dealer. In an embodiment, the optimizer may be configured to consider collateral presently allocated in existing deals. The optimizer may settle as many deals as possible with the existing portfolio and the existing collateral eligibility schedule of the new deals in a way that best fits the dealer's and/or investor's needs. For example, if an investor only accepts treasury collateral, or an investor only has a concentration limit for a particular stock, the optimizer may factor those preferences into the optimization (e.g., collateral portfolio optimization). In an embodiment, optimizations such as that disclosed in U.S. patent application Ser. No. 13/362,980, incorporated by reference in its entirety above, may be implemented to manage the collateral allocations.

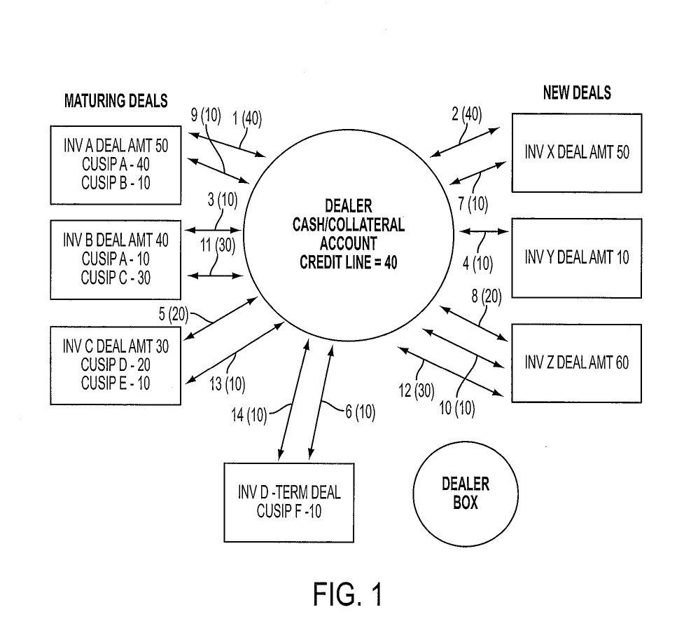

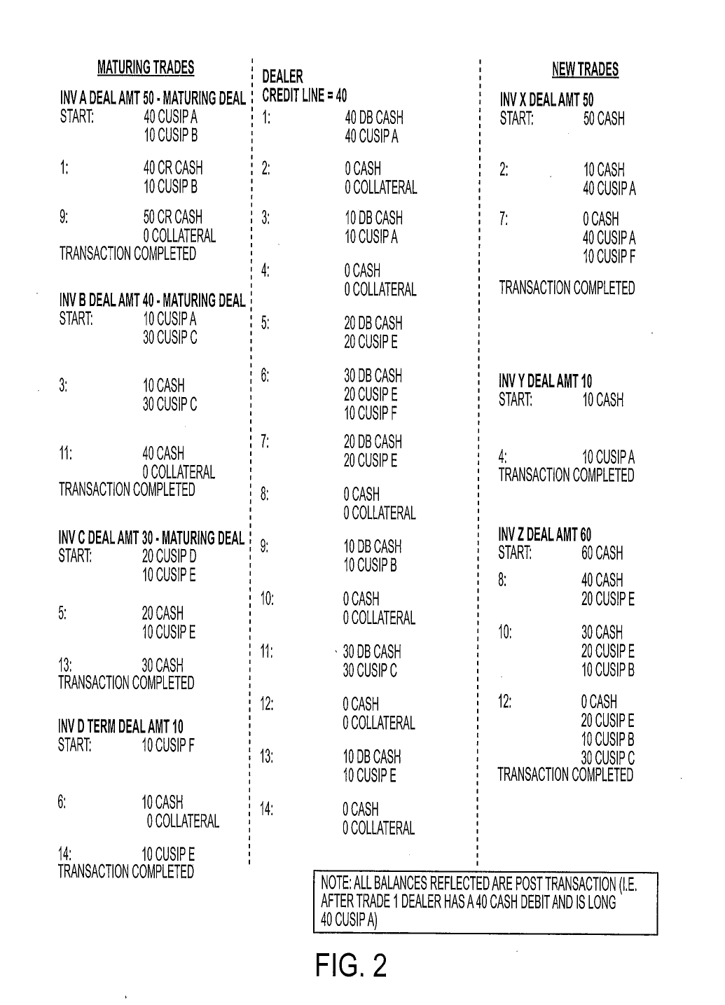

FIGS. 1 and 2 show an example of maturing Tri-Party Repurchasing trades configured for matching with new trades. It may be appreciated that the clearinghouse may know what the maturing deals are in the morning (e.g., a finite subset of the total trades). New trades may be received at the clearinghouse from the dealer and the investor throughout the business day. At the start of the settlement period (e.g., 3:30), however, the clearinghouse may identify trades that are ripe for maturity. In FIG. 1, Investor A, Investor B, and Investor C, for example, have maturing deals totaling 120 units. New trades are coming in as shown on the right hand side. At some point, the clearinghouse might elect to not accept new trades, so as to begin maturity processing. The clearinghouse may compare the maturity terms with the allocations in its system, and may run a projection to determine the deals that are to be matured, as described in greater detail below. Cash is to be paid to those deals on the left hand side of FIG. 1, while the deals on the right hand side of FIG. 1 are from the new investors that are supplying the funding for the dealer to pay off the maturing deals on the left hand side.

As described above, rather than injecting all the credit into the maturing deals en masse, the clearinghouse may be configured to attempt to fund the maturing deals by matching securities from maturing investors to needs of new investors. For example, the clearinghouse matches 120 units in new deals. The clearinghouse may further run a collateral check to make sure that the collateral that the dealer holds is unencumbered collateral. The clearinghouse may further verify that the collateral (e.g., securities) fit the new investor profiles. The new deals and the eligibility criteria of collateral on those new deals may be such that when the dealer matures the transactions, it can provide enough funding for those maturities, and the collateral fits so that new trades can be effected. The clearinghouse may then create receive and deliver instructions. The order of the operations described herein may vary, and a multitude (e.g., up to hundreds of thousands) of instructions may be processed in a matter of an hour or so.

In an embodiment, the clearinghouse may define an order for the transactions so as to receive and deliver cash and securities in a manner that doesn't expose the clearinghouse to more than the credit facility (i.e., a maximum credit limit) that any one dealer might have. Such ordering may be considered optimizing movements of collateral and liquidity by the clearinghouse. Accordingly, the clearinghouse may apply a priority algorithm to determine which dealers or investors to pay first. In various embodiments, the incremental settlements may take minutes or hours.

In one example, there might not enough cash or collateral to satisfy all the maturing deals at the maturity time. Such a situation may occur, for example, if a new trade fails or is traded late. Where the trading market is typically open later (e.g., until 5:30), while trades may typically be done before the common maturity time (e.g., 3:30) there could be late funding. In an example, the dealer might not have securities that fit the collateral profile of new investors. The dealer might do a treasury trade, but is left with only other collateral (e.g., corporate bonds). Accordingly, the clearinghouse may apply a priority algorithm which determines which maturities get paid first. For example if the clearinghouse or dealer could only pay 90 of the 120 total in deals, the algorithm may decide which investors to pay with the 90 in cash. The decision-making might be security driven or collateral type driven in some embodiments. In one example, the algorithm may pay all maturing investors on a pro rata basis.

The computer-implemented method may therefore reduce risk to the clearinghouse, and avoid a massive injection of debt to unwind maturing deals. The method further allows a clearinghouse to provide some liquidity to the deals, and thus does not require a maturing investor to bear the risk of returning a security without being paid, or require a new investor to bear the risk of paying for a security without receiving the security.

Thus, in the RVP/DVP model for Tri-Party repurchasing agreements, individual securities are repurchased from the maturing deal by the dealer using the dealer's own cash or committed facility (RVP). The securities are then repurchased to the new investor vs. cash (DVP). Accordingly the method may be characterized as a clearance process for Tri-Party Repurchase agreement settlements. As maturing deals are not funded en masse, but are funded via small individual RVP transactions until all securities are repurchased from the maturing deal, comparatively smaller amounts of credit may be needed. The maturing investor may see securities individually drain from their account against the transfer of cash of equal value for each security as the replacement (e.g., a DVP from the maturing investor's perspective). The small amounts of credit utilized may then be paid back immediately or soon thereafter upon the dealer delivering the same individual securities to a new investor against the transfer of cash. The purchasing investor may see decreases of cash as new securities are repurchased into their account (e.g., an RVP from the purchasing investor's perspective).

As described in greater detail below, RVP and DVP instructions may be created using a projected mode with optimization which may determine which securities the dealer needs to repurchase and immediately repo out to the optimal buyer of the securities. In various embodiments, inventory included in the projected allocation may include the dealer's own inventory, securities pledged to maturing deals and securities pledged to term deals. In an embodiment, should the optimal projected allocation warrant the use of securities from a term deal, the dealer may repurchase those securities needed from that term deal and then repo out new securities to that term deal later in the cycle.

In an embodiment, the RVP/DVP transactions through the dealer's account may be governed by a credit facility, meaning that the dealer might be limited in repurchasing securities (with the corresponding debit to the dealer's account) up to the credit facility. Once the credit facility maximum is reached, the dealer would begin to DVP securities to new investor accounts, and receive cash back to lower the debit.

In an embodiment, the RVP/DVP transactions may become partial settlements of each Tri-Party Repurchase Agreement trade, and may ensure finality of settlement (similar to a RVP/DVP transaction over Fedwire). Should a default situation arise, the process could stop and all parties would be fully secured with cash and/or collateral.

As understood from FIGS. 1 and 2, maturing deals may be determined as part of the “supply of collateral” and “demand for cash” equation. Other dealer's collateral may become part of the supply of collateral, and may include collateral in existing term deals and in the dealer's box of unencumbered collateral. In an embodiment, all new deals that are matched and funded may become part of the supply of cash and demand for collateral. In an embodiment, the supply of cash would be evaluated versus the demand for collateral, and placement of the collateral may be optimized to pay off maturing deals.

A collateral optimizer may create receive and deliver instructions via the dealer's account to repurchase and resell appropriate collateral to settle all maturing and new deals. Collateral in term deals may be used to satisfy new deals, or become optimized in other term deals using the same DVP/RVP instructions. In an embodiment, any term deals that are used for this purpose may then have collateral delivered to it to remove the cash. As noted above, in an embodiment, the cash debit in the dealer's account may be capped at the pre-determined committed credit facility.

In an embodiment, maturing trades may be paired off with new trades, to eliminate a need to unwind the maturing trade. Specifically, the new investors may be matched with collateral in maturing trades, so that the collateral in the maturing trade would not have to be unwound from existing allocations. As described herein, this functionality may be configured so that principal amounts associated with the old deal and the proposed new deal does not need to match. Instead, in an embodiment the paired off trade may update the maturing trade's end date, and would just unwind the delta associated with the principal amount of the new trade being less than the principal amount of the maturing trade.

In an embodiment, creating a paired off trade may start by receiving requests for the new deal from clients (e.g., dealers and investors) at the Tri-Party agent. The requests might or might not be subject to automated deal matching (ADM) in various embodiments. In an embodiment, the tri-party contract may govern whether a dealer/purchaser relationship may be enabled for the pair-off process. Once the request is received, the process may continue by determining if pair-off matching parameters are met between the maturing deal and the proposed deal. In some embodiments, a paired off trade may be determined where all parameters are met. In other embodiments, a paired off trade may be determined where one or more of the parameters are met. In some such embodiments, some parameters may be more important than others (and may be designated as required for the match, or optional but preferred). While the matching parameters may vary across embodiments, in some embodiments the matching parameters may include BID matching (e.g., basket identifier), deal identifier, and/or date information (e.g., existing deal with end date being the same as the start date of a new deal).

As noted above, in some embodiments there may be a principal difference in one or more of the paired off trades. Specifically, the principal amount on the new trade may be greater than the principal amount of the maturing trade (i.e., a principal increase trade), or the principal amount of the new trade may be less than the principal on the maturing trade (i.e., a principal decrease trade). It may be appreciated that a maturing deal, or a deal where the principal amount has been decreased, may be considered a DVP transaction, where collateral is being returned back to the dealer in exchange for the dealer giving cash back to the investor. It may also be appreciated that a new deal, or a deal where the principal amount has been increased, may be considered a RVP transaction, where collateral is being allocated from the dealer to the deal in exchange for the investor giving cash to the dealer.

In an embodiment incremental settlement may be implemented by matching DVP transactions to RVP transactions to allow a substantially simultaneous exchange of collateral from a maturing/principal-decrease deal to a new/principal-increase deal, while substantially simultaneously moving cash from the new/principal-increase deal to the maturing/principal-decrease deal. In an embodiment, the matching may be performed at the position level, which may facilitate incremental settlement of a deal through a set of partial and smaller settlements. In an embodiment, the matching may be performed in the same database transaction, or can occur in separate transactions when an amount of exposure is backed by net free equity (NFE) or credit. In an embodiment, an amount of tolerable NFE or credit may be defined by the custodian. In an embodiment, a single DVP or RVP transaction may be split into smaller transactions to reduce usage of substitution cash and NFE.

In an embodiment, where there is a principal difference between the new trade and the maturing trade, cash journal entries may be created to track and mark the anticipated credit or debit resulting from the principal difference. Upon pair-off of a principal increase pair-off trade, an existing anticipated principal debit entry may be deleted, and a pending credit entry may be created for the net principal difference between the matured trade and the pair-off trade. It may be appreciated that in an embodiment where there is a principal increase, funds may ultimately settle to the dealer. Similarly, upon pair-off of the new trade in a principal decrease pair-off trade, an existing anticipated principal debit entry may be deleted, and a pending debit entry may be created for the net principal difference between the matured trade and the pair-off trade. In an embodiment with a principal decrease, funds may settle to the investor. It may be appreciated that one or more depositories may be associated with the cash flows for the principal difference transactions, (e.g., with the dealers and the investors), so as to receive liquidity on loan from the clearinghouse or Tri-Party agent, or store outstanding credits.

In an embodiment, the system may be configured to match new deals to maturing deals to create the smallest possible principal difference. In an embodiment, the matching of the new deals to the maturing deals may be configured to create the smallest possible positive principal difference. For example, if a new deal N is 90 units, and there are maturing deals M1 with 60 units and M2 with 70 units, N (90 units) would be matched with M2 (70 units), because the net principal difference between the new deal N and the maturing deal M2 would be +20, instead of +30 between N and M1.

As another example, if the new deal N is 90 units, and maturing deal M1 is 120 units, and M2 is 60 units, then the net principal difference between N and M1 would be −30 units, and the net principal difference between N and M2 would be +30 units. As such, in an embodiment where the smallest possible positive principal difference is desired, the system may pair off the new deal N with M2, because it would result in a principal increase. In an embodiment where a principal increase or a principal decrease is not requested, then the assignment may be between N and either M1 or M2 (net principal differences of −30 and +30 respectively). In an embodiment, other selection criteria may be utilized to distinguish between M1 and M2 in such an occurrence, or the selection may be random, or the selection may be presented to one or more of the parties for user selection.

In an embodiment where multiple new deals are received sequentially, the system may match the first received new deal against the known maturing deals first, before attempting to match the second received new deal to remaining unmatched maturing deals. In other embodiments, a delay may be established to permit a plurality of new deals to be compared to a plurality of maturing deals. In some such embodiments, the deals may be matched utilizing a plurality of pair-off parameters to determine a best pairing off of the new deals and the maturing deals.

In some embodiments, the system may be configured to permit modifying the paired off trades (and/or other trades) prior to settlement. For example, upon receiving a deal modification request (e.g., from either the dealer or the investor), the system may increase or decrease the deal amount depending on whether there is a principal increase deal or a principal decrease deal. For example, to change the principal amount on an existing deal, if the modified principal amount is greater than the proposed settlement principal amount, a pending principal credit may be created equal to the net difference between the proposed settlement principal amount and the modified principal amount, where such funds may be settled to the dealer. For example, if the initial principal increase was from 80 to 100 (creating a pending credit of 20), but is to be modified from 100 to 150, then the pending credit of 20 may be deleted from the cash journal entry, and a pending credit of 70 (i.e., the net difference from the settled principal amount of 80 and the modified principal amount of 150) may be created.

Similarly, to decrease the principal amount (to an amount that still results in a net increase), the pending credit may be deleted, and a new pending credit equal to the net difference of the proposed settlement principal amount and the modified principal amount may be created. For example, where the original principal increase is from 80 to 100, and a pending credit of 20 has been created, to decrease the principal from 100 to 90, the pending credit of 20 may be deleted, and a pending credit of 10 (the net difference between 80 and 90) may be created. This may also apply to new deals (e.g., where the pending credit is the entirety of the deal amount), such that the prior pending credit is deleted, and a new pending credit according to the terms of the new deal is created.

In an embodiment, if the current principal amount is less than the proposed settlement principal amount, then a pending principal debit entry may be created, equal to the net difference between the settled principal amount and the modified principal amount. Funds may accordingly be settled to the investor. For example, if the principal decrease is initially from 100 to 80, where a pending debit of 20 has been created, to decrease from 80 to 40, the pending debit of 20 may be deleted, and a pending debit of 60 may be created (the net difference from the initial amount of 100 and the modified principal amount of 40). In some embodiments, an increase that still results in a net principal decrease may be treated similarly. For example, if the initial principal decrease is from 100 to 80 (creating a pending debit of 20), an increase from 80 to 90 may be processed by the system deleting the pending debit of 20, and creating a new pending debit of 10 (the net difference from the original amount of 100 and the new principal amount of 90).

In an embodiment, deals may be modified after partial settlement thereof. Specifically, for dealer cash entry (with the modified principal amount being greater than the settled principal amount), the system may be configured to delete the previous pending principal entry, and create a pending principal credit entry equal to the new net principal increase (the modified principal amount minus the settled principal amount). As settlement occurs, the system may create a settled credit for the sum settled amount, and the funds may be settled to the dealer. As an example, if the principal increase is from 75-100, the settled principal amount is 75, while the pending credit created is 25. To settle funds of 15 to the dealer, the settled principal amount becomes 90. To process this, the system may delete the pending credit of 25, create a settled credit of 15, and create a pending credit of 10 (the net difference from the settled principal amount of 90 and the modified principal amount of 90. To then increase the principal from 100 to 150, for example, the pending credit of 10 would be deleted, and a pending credit of 60 (the net difference from the settled principal amount of 90 and the modified principal amount of 150) may be created.

As another example, if a principal increase is from 75 to 100, the settled principal amount would be 75, and a pending credit of 25 would be created. To settle funds of 10 to the dealer, the settled principal amount would become 85, and the system would delete the pending credit of 25, create a settled credit of 10, and create a pending credit of 15 (the net difference from the settled principal amount of 85 and the modified principal amount of 100). To then decrease the principal from 100 to 85, the system would delete the pending credit of 15. No new pending entry would be needed, because the net difference from the settled principal amount of 85 and the modified principal amount of 85 would be zero.

In an embodiment, if the new deal amount is less than the settled principal amount, the system may create a new pending principal debit entry equal to the new net principal decrease (i.e., the new deal amount minus the settled principal amount). For example, with a principal increase from 75 to 100, the settled principal amount would be 75, while a pending credit of 25 would be created. To settle funds of 10 to the dealer, the settled principal amount would become 85, and the system would delete the pending credit of 25, create a settled credit of 10, and create a pending credit of 15 (the net difference from the settled principal amount of 85 and the modified principal amount of 100. To then decrease the principal from 100 to 60, for example, the pending credit of 15 would be deleted and a pending debit of 25 (the net difference from the settled principal amount of 85 and the modified principal amount of 60) would be created.

In some embodiments it may be possible to modify the principal amount after a full settlement. In an embodiment, for dealer cash entry, if a new deal amount is greater than the settled principal amount, the system may create a pending principal credit equal to the new net principal increase (modified principal amount minus settled principal amount). As settlement occurs, the system may create a settled credit for the sum settled amount. For example, in an embodiment, if there is a principal increase from 75 to 100, the system would have created a pending credit of 25. To settle funds of 15 to the dealer, the settled principal amount would become 90. The system would delete the pending credit of 25, create a settled credit of 15, and create a pending credit of 10 (the net difference from the settled principal amount of 90 and the modified principal amount of 100). To then increase the principal from 100 to 150, for example, the system would delete pending credit of 10, and create a pending credit of 60 (the net difference from the settled principal amount of 90 and the modified principal amount of 150). To then settle funds of 60 to the dealer, the settled principal amount would become 150. The system would then delete the pending credit of 10, and create a settled credit of 75 (the full amount settled).

If the modified principal amount is less than the settled principal amount, the system may create a pending debit entry. For example, with a principal increase from 75 to 100, the settled principal amount is 75, and a pending credit of 25 has been created. To then settle funds of 10 to the dealer, the settled principal amount becomes 85, and the system may delete the pending credit of 25, create a settled credit of 10, and create a pending credit of 15 (the net difference from settled principal amount of 85 and new deal amount of 100). To then, decrease the principal from 100 to 60, the system may delete the pending credit of 15, and create a pending debit of 25 (the net difference from settled principal amount of 85 and new deal amount of 60). To then settle funds of 25 to the investor, the system may delete the pending debit of 25, and create a settled debit of 15 (the full amount settled).

It may be appreciated that in some embodiments the system may be configured to facilitate cancellation of deals. In an embodiment, such cancellation may be possible before or after settlement, either before on the start date for the deal. It may be appreciated that after the start date of a deal, a paired of trade might not be cancelable. After successful cancellation, the deal may be available for unwinding from other obligations (e.g., where the collateral has been rehypothecated). In an embodiment, the principal amount to unwind may be the settled principal amount (e.g., the previous deal amount plus the net settled amount). In an embodiment, once a paired off deal is canceled, parties may be able to add a new deal, which could be paired off with the cancelled pair-off deal. In an embodiment, the new pair-off deal may have the same principal, a principal increase, or a principal decrease from the canceled pair-off deal, and may be processed similarly to the deal modification described above.

As noted above, in various embodiments the system may be configured to process DVP/RVP settlement of deals in an incremental manner. By settling in increments, the amount lent to the dealer would be less at any given time than it would be in settlement in masse. It may be appreciated that as the dealer starts settling the transaction, the dealer who has borrowed cash may be able to utilize incrementally released securities in other tri-party deals to receive more cash. In an embodiment, dealer identifiers may be selectively enabled for DVP/RVP incremental settlement. In an embodiment, when a trade is not enabled for a DVP process, new trades and principal increases on non-maturing trades may settle via a trade approval process. In an embodiment, such trades might not be approved if the trade is undercollateralized, or if cash is not available in the investor's cash account. In an embodiment, a tolerance level may be associated with the investor's cash account, to allow settlement to proceed when the amount to be paid is within the threshold. For example, such a threshold may be nominal (e.g., $1), or may be associated with a line of credit associated with the settling party.

In an embodiment, the system may be configured to settle via the DVP process in a manner that delivers positions into a trade and simultaneously (or substantially simultaneously) receives payment from investor cash that has been deposited into the investor cash account (a deliver versus payment, or DVP, settlement). The net principal difference, as described above, would be the amount that needs to settle as paid principal to the dealer. It may be appreciated that the DVP settlement process can result in a full settlement or a partial settlement status. In a full settlement, the dealer has delivered collateral to fully collateralize the pair-off trade and has received funds from the investor for the full principal increase. Accordingly, the security obligation would be met. In a partial settlement, however, the dealer has delivered some collateral into the pair-off trade (e.g., trade may still be undercollateralized), and has received funds from the investor for the incremental collateral delivered. Alternatively, the dealer may deliver collateral to fully collateralize the pair-off trade, but has received a portion of the principal increase cash from the investor.

In an embodiment, on a principal increase trade, or new trade, the DVP settlement may occur when the trade has received both sufficient cash in investor cash account and collateral in trade to satisfy the obligation. In some embodiments, it might not matter which of the cash or collateral is received first, as long as both are there before settlement can occur. As cash is received in the investor cash account, or collateral is allocated to the trade, the system may check if DVP settlement can occur. In an embodiment, the DVP settlement may occur any time there is a substitution of collateral from a maturing or principal decrease deal after a settlement time has been reached. In an embodiment, if settlement time has not been reached, substitution cash may be added to the deal as collateral.

Generally, the collateral value allocated may be shown as an individual DVP (per position) equivalent to the cash to be debited. In some embodiments, the DVP may not be equal to the collateral value. When a previous trade has collateral value greater than the required collateral amount of the previous trade, there may be an immediate settlement based on the cash available in the investor cash account. In an embodiment, when the existing trade receives more collateral value than its required collateral amount, the total settlement should never exceed the principal increase amount. In an embodiment, the existing trade should meet the previous trade's required collateral amount before the settlement of investor's cash can be paid to the dealer. In an embodiment, once the trade is topped off to the accrued interest amount (if accrued interest is required to be collateralized), then system may settle the principal increase obligation (DVP). It may be appreciated that in some embodiments, if collateral is allocated into the trade, and cash is received into the investors cash account afterwards, the DVP transaction may reflect zero par allocated versus the settled amount. If cash is received first into the investors cash account, and then collateral is allocated into the trade afterwards, the DVP transaction may reflect collateral value allocated versus the settled amount. In an embodiment, the system might not record a DVP entry reflecting collateral value versus a zero amount settled when collateral is allocated into the trade, and full settlement has already been reached.

In an embodiment, DVP settlement may occur as part of manual unwinds which may remove excess collateral above a projected settled principal amount (plus accrued unpaid interest in some embodiments, if required). In an embodiment, collateral may be removed by first removing manually substituted cash, before removing automatically substituted cash. In an embodiment, excess collateral may be removed after the automatically substituted cash. In an embodiment, the excess collateral may be removed in descending order of NFE margin.

It may be appreciated that in some embodiments, as new positions are delivered (allocated) or rolled to the trade, and incoming funds from the investor are deposited into the investor cash account, the pending credit entry to the dealer should settle incrementally. The timing of such settlement may vary across embodiments. For example, in an embodiment, the incremental settlement may occur at a plurality of set times throughout the day (e.g., every 5 minutes, or at designated times). In an embodiment, the incremental settlement may occur immediately upon a condition being met. For example, in an embodiment, the system may be configured to process settlements upon receipt of eligible cash and/or new deal proposals that facilitate pairing off, as described above.

In an embodiment, when there is a demand deposit account (DDA), a DVP/RVP settlement may be performed when both collateral and cash are available. For maturing/principal increase deals that are short collateral, the dealer may be required to provide cash or extra collateral to support the settlement. For new deals or principal increase deals where the dealer lacks sufficient collateral, the dealer may be required to provide cash or other collateral to facilitate settlement from the investor to the dealer. Where there is no DDA (or the DDA is separate from the collateral management or settlement system), DVP/RVP settlement may occur through position movement, and cash may be treated externally to the DVP/RVP transaction where needed.

It may be appreciated that RVP settlements for a principal decrease may be considered RVP per position repurchased by the dealer. In an embodiment, RVP settlement may occur whenever there is an allocation to a new or principal increase deal, and cash is available in a DDA. In an embodiment, if a DDA is not linked or associated with the deal, RVP settlement may occur when the position alone is being allocated to the deal. In an embodiment, if the trade is enabled for RVP settlement, then upon settlement a collateral value in excess of the required collateral amount may be removed from the trade and into the dealer box. In an embodiment, the repurchased collateral removed from the trade may reflect as an individual RVP transaction. The dealer may receive each position into their dealer box against credit posted to the investor cash account. As indicated above, the pending principal debit entry may settle incrementally. If the trade is not enabled for RVP settlement, however, then upon principal decrease settlement, a collateral value in excess of the required collateral amount may be removed from the trade and into the dealer box, and the pending principal debit entry should settle.

In some embodiments of a principal decrease settlement via both RVP and non-RVP processes, the settlement might not occur if there is no account for the trade (e.g., a demand deposit account), however might occur once account details are available. Additionally, full settlement on a principal decrease may occur with the trade remaining undercollateralized. It may be appreciated that, in some embodiments, the collateral repurchased by the dealer should not result in the trade being further undercollateralized, or less than a defined collateral maintenance level (CML). In an embodiment, the CML may be computed as a minimum amount of collateral that should be allocated to the deal as a custodial obligation. In an embodiment, the CML may be computed as:

$$C M L = MIN ( PositionCollateralValue + \frac{Cash}{CashMarginRate} , TotalRequiredCollateral ( SettledPrincipalAmount ) ) ,$$

where PositionCollateralValue is the Cash Value divided by the investor margin of collateral allocated to deal (the Cash Value being the sum of the market value and the accrued interest), the cash is the cash already allocated to the deal, the cash margin rate is the rate defined by the investor for margining cash in the deal, and TotalRequiredCollateral (SettledPrincipalAmount) is the amount of cash settled from the investor to the dealer plus any accrued interest on the deal if the deal is configured to include accrued interest as part of the total required collateral.

In an embodiment, each position removed should abide by rules associated with the security received into the dealer box. Such rules may include, for example, minimum/multiple rules associated with security and the CMLs. Upon settlement, cash (e.g., auto cash/manual cash) that exceeds the trade's CML may be credited back to the dealer, and debited from the investor's account (e.g., the investor's demand deposit account).

During a principal decrease, in some embodiments the settlement obligation may be repurchased by the dealer based on a set prioritization. In an embodiment, the prioritization may include manually applied cash in trade, automatically applied cash in trade, and collateral which has a lowest (e.g., closest to 0%) NFE margin (the margin defined by the custodian) applied. In an embodiment, if all positions in trade have same NFE margin percentage, the system may select the position by the collateral value which would result in minimum number of positions removed (i.e., the largest piece). In an embodiment, if all of the positions have the same NFE and collateral value, the system may randomly select any position to be removed. It may be appreciated that by selecting the collateral which has the lowest NFE margin percentage, the investor assumes the same risk, whereas the dealer would receive the NFE benefit for the collateral returned to their dealer box.

For principal decrease on pair-off and non-pair-off trades enabled for RVP settlement, in some embodiments the excess collateral value to be repurchased may be represented as an individual RVP (per position) equivalent to the cash to be credited to the investor. It may be appreciated that the RVP settlement process for principal decrease should result in a full settlement. If the trade has collateral value less than the current required collateral amount, the settlement would result in zero collateral moved against cash payment to the investor cash account, and no collateral would be removed from the trade. When the trade has collateral value more than the required collateral amount, the settlement would result in the excess collateral value to be removed against the cash payment to the investor cash account. It may be appreciated that the cash payment should not exceed the net principal difference in some such embodiments. It may be appreciated that in some embodiments of RVP settlements, the system may create a settled debit equal to the collateral value of the principal removed.

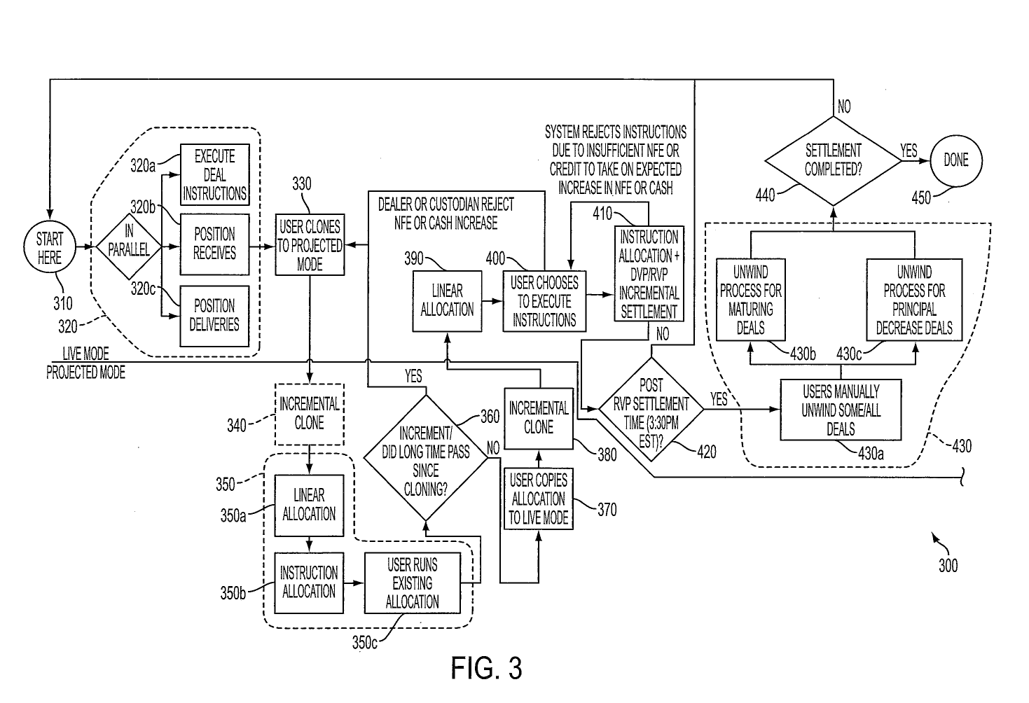

FIG. 3 illustrates an embodiment of a process 300 configured to match DVP and RVP transactions together such that they may occur substantially simultaneously (e.g., in the same database transaction), or near each other in time (if in different database transactions. As shown, in some embodiments the system operating the process may be configured to manage exposure of the custodian when the DVP and RVP occur in separate transactions, to limit cash usage and NFE usage to stay within defined tolerances.

Specifically, the process 300 of FIG. 3 starts at 310, and at 320 (generally in parallel) receives and processes instructions to modify positions and deals. As shown, for example, process 300 may include executing deal instructions at 320a, managing position receives at 320b, and manage position deliveries at 320c. As noted above, in some embodiments a projected trading/allocation environment (or mode of the system) may be utilized in lieu of experimental actions in a live trading/allocation environment (or mode of the system). Accordingly, process 300 may continue at 330 by copying at least portions of the dealer's portfolio to the projected environment. It may be appreciated that such copying may comprise copying of both deals and collateral from the live environment to the projected environment. In an embodiment, copying/cloning may be incremental, as shown at 340, and described in greater detail below.

In an embodiment, allocations may proceed at 350 in the projected environment, including linear allocations 350a and instruction allocations 350b. In an embodiment, the user of the system may run existing allocation projections at 350c. In an embodiment, prior to the maturity time (e.g., 3:30 pm EST), the allocations to deals at 350 in the projected mode may be up to the settled principal amount, or the amount of cash that has been transferred from the lender to the dealer, (i.e., the loan amount of the deal). In an embodiment, after the maturity time (e.g., 3:30 pm EST), the allocations to deals at 350 in the projected mode may be up to the projected settled principal amount. In an embodiment, the projected settlement principal amount may represent the future settled principal amount assuming the deals were to settle, and there was sufficient cash and collateral to support the settlement. In an embodiment, for deals where maturity date is on or before the present date, the projected settlement amount may be 0 (zero). In an embodiment, for deals where loan amount is less than or equal to the settled principal amount, and the maturity date is after the present date, the projected settled principal amount may be equal to the loan amount. In an embodiment, for deals where the loan amount exceeds the settled principal amount, and maturity date is after the present date, the projected settled principal amount may be the minimum of the settled principal amount plus the available investor cash in a DDA, and the loan amount. In an embodiment, for deals that share a DDA, the projected settled principal amount may be influenced by the DDA cash being either distributed to a deal with the minimum of the loan amount minus the settled principal amount or being distributed to a deal that can maximize settlement (e.g., through an optimization computation). In an embodiment, any ineligible & excess collateral may be returned back to the dealer box. In some embodiments, however, deals can be flagged to not return excess collateral. In an embodiment, collateral eligibility checking may be done using parallel programming techniques to speed up the process.

In an embodiment, the allocation can be as allocated in the live mode, or can be a new allocation starting from the dealer box, or can be a combination thereof. In an embodiment, users can also selectively choose the “Net Par difference,” which may keep the allocations previously performed in projected mode, but may validate eligibility and remove ineligible and excess collateral.

In an embodiment, the dealer may perform allocations at 350 in the projected mode to top off their deals and re-optimized the usage of their collateral, as illustrated at 350c. The dealers may use a variety of allocation methods, including but not limited to Auto Allocation, Message Based Allocation, Allocation Feed Files, Dynamic Collateral Optimization, or Collateral Portfolio Optimization. In an embodiment, the dealers may choose to allocate to settled principal amount (prior to the maturity time, e.g., 3:30 pm EST), or the projected settled principal amount (post the maturity time, e.g., 3:30 pm EST).

In an embodiment, after the deals are topped off in the projected mode, the dealer may optionally to perform the incremental copying, which may refresh new settled transactions (deals and collateral) into the projected mode, and therefore may return to 330 to refresh the live mode transactions, and increment at 340. In an embodiment, large dealers may perform incremental cloning/copying if a long period of time has elapsed since the original clone to projected mode, as shown at 360. In an embodiment, the “Net Par Difference” incremental cloning/copying may add new received collateral from live mode into the projected mode dealer box. In an embodiment, such incremental cloning/copying may remove positions in projected mode that were delivered in live mode back to market. In an embodiment, such incremental cloning/copying may apply settled deal changes from live mode. Further, in some embodiments, the incremental cloning/copying may remove excess or ineligible collateral from the deals considering the updated projected settled principal amount.

In an embodiment, after performing allocations in the projected mode, process 300 may continue at 370 with the dealer executing a process to copy the allocations to live mode. In an embodiment, first a position only “Net Par Difference” might execute at 380, where positions may be refreshed again in projected mode to match recent deliveries and receives in live mode. It may be appreciated that this might short some deals in the projected mode.

In an embodiment, process 300 may continue at 390 by identifying differences between the live mode and the projected mode allocations. The differences may become allocation or substitution instructions. Allocation instructions to new or principal increase deals may potentially become DVP instructions, assuming there was cash to support the settlement or was against a deal without a DDA account. Substitution instructions to maturing or principal decrease deals may potentially become RVP instructions assuming they were performed after the settlement time. In an embodiment, the Allocation/Substitution instructions may be created at 390, but would not yet execute in the live mode. Specifically, in an embodiment, while creating the pending allocation & substitution instructions, the process 300 may simulate the instructions in memory and identify certain projected values associated therewith (which may assume successful execution of the instructions). For example, the process 300 may compute a projected peak NFE usage, which may be the maximum NFE usage either in a transition state or an end state. In an embodiment, the process 300 may compute a projected ending NFE usage, which may be the NFE usage in the end state. In an embodiment, the process 300 may additionally or alternatively compute a projected peak cash usage, the maximum amount of cash that is needed to be substituted against collateral to maintain a CML in transition and end states MINUS the cash present in the deals during the start state. Further, the process 300 may additionally or alternatively compute a projected ending cash usage, the amount of cash that should remain in the deals after all the instructions have been executed, minus the cash present in the deals during the start state.

In an embodiment, process 300 may continue at 400 with the users reviewing the expected increase/decrease to both NFE and cash to determine whether they wish to continue with the allocation. In an embodiment, if the exposure is too great, the dealer, custodian or other user of the system operating the process 300 may choose to return to 330, and try an alternative allocation with updated deal and position information. In an embodiment, if users choose to accept the expected increase/decrease to both NFE and cash, they may choose to execute the instructions, and proceed to 410. In an embodiment, the system operating the process 300 may perform an automated check to validate that the dealer has sufficient NFE or credit to available in the event of any expected NFE or cash increase. In an embodiment, if the validation fails, the user may return to 400 and decide if they need to go through another projection at 330, or possibly deliver in more cash to prefund the expected increase exposure to the custodian.

In an embodiment, settlement at 410 may occur through the act of allocation as positions are allocated to a deal where the settled principal amount is less than the loan amount, and there is either funds available in a DDA, or if there is no DDA account. In an embodiment, as positions are substituted from a deal where the loan amount is less than the settled principal amount, or if the deal is maturing, then settlement may occur after the settlement time (e.g., 3:30 pm EST). Prior to the settlement time (e.g., 3:30 pm EST), cash may be substituted against the position. It may be appreciated that in some embodiments RVP settlement may occur prior to the settlement time, if market regulations allow for such. Accordingly, as shown at 420 prior to the settlement time, process 300 may repeat by returning to 310. In an embodiment, if allocations or substitutions are performed to a deal which already reached settlement, or cannot settled at the time due to the time of day or lack of cash, then no settlement would occur. It may be appreciated that substitution cash could be removed from deals as positions are allocated to them.

In an embodiment, after the settlement time (e.g., 3:30 pm EST), the custodian or other entity operating the system may choose to unwind any remaining maturing and principal decrease deals, as shown at 430 if the dealer has sufficient credit or cash. Specifically, at 430a, users may manually unwind at least some of the deals, and engage in the unwinding process for maturing deals (430b) and principal decrease deals (430c). In an embodiment, where there is insufficient credit or cash, or where there are additional deals still requiring settlement for maturing on the present day, the dealer may at 440 start the settlement cycle again by returning 310. In an embodiment, the process 300 may then repeat until it is determined at 440 that all settling deals have settled, and process 300 ends at 450.

Those skilled in the art will appreciate that the embodiments described herein can be implemented using a server, computer, database, communications and programming technology, each of which implements hardware or software or any combination thereof. Embodiments of this disclosure may be implemented in the form of a computer program product on a computer-readable storage medium having computer-readable program code means embodied in any suitable computer-readable storage medium, including hard disks, CD-ROM, RAM, ROM, optical storage devices, magnetic storage devices, and/or the like.

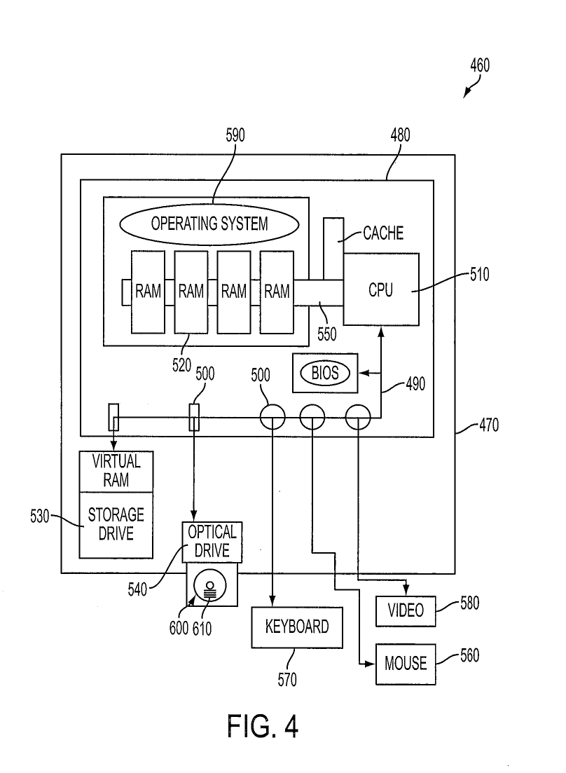

For example, FIG. 4 illustrates a high level block diagram of an exemplary computer system 460 which may be used to perform embodiments of the processes disclosed herein, including but not limited to process 300. It may be appreciated that in some embodiments, the system performing the processes herein may include some or all of the computer system 460. In some embodiments, the computer system 460 may be linked to or otherwise associated with other computer systems 460. In an embodiment the computer system 460 has a case 470, enclosing a main board 480. The main board has a system bus 490, connection ports 500, a processing unit, such as Central Processing Unit (CPU) 510, and a data storage device, such as main memory 520, storage drive 530, and optical drive 540. Each of main memory 520, storage drive 530, and optical drive 540 may be of any appropriate construction or configuration. For example, in some embodiments storage drive 530 may comprise a spinning hard disk drive, or may comprise a solid-state drive. Additionally, optical drive 540 may comprise a CD drive, a DVD drive, a Blu-ray drive, or any other appropriate optical medium.

Memory bus 550 couples main memory 520 to CPU 510. A system bus 590 couples storage drive 530, optical drive 540, and connection ports 500 to CPU 510. Multiple input devices may be provided, such as for example a mouse 560 and keyboard 570. Multiple output devices may also be provided, such as for example a video monitor 580 and a printer (not shown). In an embodiment, such output devices may be configured to display information regarding the processes disclosed herein, including but not limited to cash amounts, trade details, and so on. It may be appreciated that the input devices and output devices may alternatively be local to the case 470 and the computer system 460, or may be located remotely (e.g., interfacing with the computer system 460 through a network or other remote connection).

Computer system 460 may be a commercially available system, or may be proprietary design. In some embodiments, the computer system 460 may be a desktop workstation unit, and may be provided by any appropriate computer system provider. In some embodiments, computer system 460 comprise a networked computer system, wherein memory storage components such as storage drive 530, additional CPUs 510 and output devices such as printers are provided by physically separate computer systems commonly tied together in the network. Those skilled in the art will understand and appreciate the physical composition of components and component interconnections comprising computer system 460, and select a computer system 460 suitable for performing the methods disclosed herein.

When computer system 460 is activated, preferably an operating system 590 will load into main memory 520 as part of the boot sequence, and ready the computer system 460 for operation. At the simplest level, and in the most general sense, the tasks of an operating system fall into specific categories—process management, device management (including application and user interface management) and memory management.

In such a computer system 460, the CPU 510 is operable to perform one or more embodiments of the methods described above. Those skilled in the art will understand that a computer-readable medium 600 on which is a computer program 610 for performing the methods disclosed herein may be provided to the computer system 460. The form of the medium 600 and language of the program 610 are understood to be appropriate for computer system 460. Utilizing the memory stores, such as one or more storage drives 530 and main system memory 520, the operable CPU 510 will read the instructions provided by the computer program 610 and operate to perform the methods disclosed herein, such as process 300.

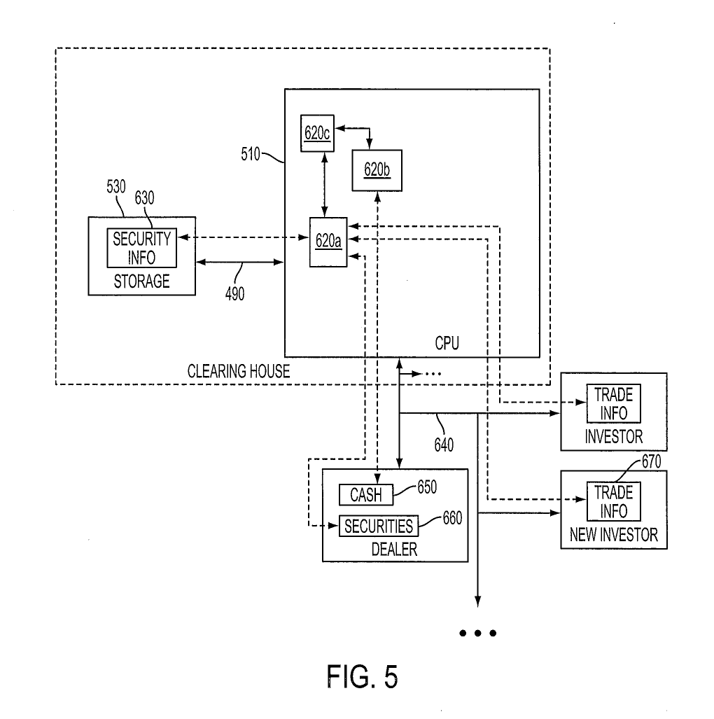

As shown in FIG. 5, in some embodiments the CPU 510 (either alone or in conjunction with additional CPUs 510) may be configured to execute one or more computer program modules 620, each configured to perform one or more functions of the processes described herein. For example, in the illustrated embodiment, at a CPU 510 operated by a clearinghouse, a computer program module 620a is configured to obtain, on electronic storage media such as the storage drive 530, security information 630 associated with a plurality of securities securitizing Tri-Party repurchasing agreements between one or more dealers and one or more investors. The storage drive 530 may be linked to the CPU 510 via the system bus 490, through a network (e.g., a network 640), or any other appropriate data link. The CPU 510 may also be configured with a module configured to execute a computer program module 620b configured to receive a cash amount 650 from a dealer, the cash amount being less than required to repurchase an entirety of securities associated with a Tri-Party repurchasing agreement between the dealer and an investor. The CPU 510 may also be configured with a module configured to execute a computer program module 620c configured to release a subset of the entirety of securities to the dealer, the subset of the entirety of securities being repurchased by the cash amount received from the dealer. As shown in the illustrated embodiment the module 620c is interfaced with the module 620a that is linked with the security information 630. As such, release of securities 660 to the dealer may be effectuated by the module 620a at the direction of the module 620c. In effect, the plurality of modules 620, operating over one or more CPUs 510, may cooperate with one another to perform the methods described herein.

In an embodiment, one or more of the plurality of modules 620, including (in the illustrated embodiment, module 620c) may be configured to match the security information 630 of one or more securities of the plurality of securities securitizing Tri-Party repurchasing agreements with a new investor. For example, a principal amount associated with a Tri-Party repurchasing agreement represented in the security information 630 may be matched with a principal amount of a proposed new trade 670 associated with the new investor. It may be appreciated that interfaces with the dealer(s) and/or investors(s) may be via the network 640, which may effectuate electronic funds transfers and other financial and/or data exchanges. In an embodiment, electronic funds and security transfers may be routed through one or more specific networks associated with such transactions. In an embodiment, one or more of the modules, including, for example, module 620b, may be configured to lend credit to the dealer to cover principal differences in settlements between investors and dealers, as described in greater detail above.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims. Accordingly, various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A system for settling trades in Tri-Party repurchasing agreements, the system comprising:
one or more processors configured to execute one or more computer program modules configured to:
obtain, on electronic storage media accessible to the one or more processors, security information associated with a plurality of securities securitizing Tri-Party repurchasing agreements between one or more dealers and one or more investors;
execute, on the one or more processors of the computer system, one or more computer program modules configured to receive a cash amount from a dealer, the cash amount being less than required to repurchase an entirety of securities associated with a Tri-Party repurchasing agreement between the dealer and an investor; and
execute, on the one or more processors of the computer system, one or more computer program modules configured to release a subset of the entirety of securities to the dealer, the subset of the entirety of securities being repurchased by the cash amount received from the dealer.

2. The system of claim 1, wherein the one or more processors are further configured to display, on an electronic display communicatively linked with the one or more processors of the computer system, one or more of the cash amount received from the dealer and the subset of the entirety of securities.

3. The system of claim 1, wherein the one or more processors are further configured to execute one or more computer program modules configured to match the security information of one or more securities of the plurality of securities securitizing Tri-Party repurchasing agreements with a new investor.

4. The system of claim 3, wherein matching the security information of the one or more securities with the new investor comprises comparing a first principal amount associated with each Tri-Party repurchasing agreement with a second principal amount of a proposed new trade associated with the new investor.

5. The system of claim 4, wherein, when the first principal amount is less than the second principal amount, a pending credit is computed for a principal increase to be settled to a dealer associated with the first principal amount.

6. The system of claim 4, wherein, when the first principal amount is greater than the second principal amount, a pending debit is computed for a principal decrease to be settled to an investor associated with the first principal amount.

7. The system of claim 6, wherein the one or more processors are further configured to execute one or more computer program modules configured to lend credit to the dealer to cover the principal decrease being settled to the investor.

8. The system of claim 7, wherein the credit is capped by a clearinghouse associated with the Tri-Party repurchasing agreement.

9. The system of claim 4, wherein the security information of the one or more securities are matched to the new investor to create a smallest possible principal difference between the first principal amount and the second principal amount as compared to a third principal amount associated with others of the plurality of securities associated with other Tri-Party repurchasing agreements.

10. The system of claim 1, wherein the one or more processors are further configured to execute one or more computer program modules configured to generate projected allocations of collateral in maturing Tri-Party Repurchasing agreements with new investors, and allow a user to selectively implement the projected allocations.

11. A computer-implemented method of settling trades in Tri-Party repurchasing agreements, wherein the method is implemented in a computer system comprising one or more processors configured to execute one or more computer program modules, the method comprising;
obtaining, on electronic storage media accessible to the one or more processors security information associated with a plurality of securities securitizing Tri-Party repurchasing agreements between one or more dealers and one or more investors;
executing, on the one or more processors of the computer system, one or more computer program modules configured to receive a cash amount from a dealer, the cash amount being less than required to repurchase an entirety of securities associated with a Tri-Party repurchasing agreement between the dealer and an investor; and
executing, on the one or more processors of the computer system, one or more computer program modules configured to release a subset of the entirety of securities to the dealer, the subset of the entirety of securities being repurchased by the cash amount received from the dealer.

12. The method of claim 11, further comprising displaying, on an electronic display communicatively linked with the one or more processors of the computer system, one or more of the cash amount received from the dealer and the subset of the entirety of securities.

13. The method of claim 11, wherein the one or more processors are further configured to execute one or more computer program modules configured to match the security information of one or more securities of the plurality of securities securitizing Tri-Party repurchasing agreements with a new investor.

14. The system of claim 13, wherein matching the security information of the one or more securities with the new investor comprises comparing a first principal amount associated with each Tri-Party repurchasing agreement with a second principal amount of a proposed new trade associated with the new investor.

15. The system of claim 14, wherein, when the first principal amount is less than the second principal amount, a pending credit is computed for a principal increase to be settled to a dealer associated with the first principal amount.

16. The system of claim 14, wherein, when the first principal amount is greater than the second principal amount, a pending debit is computed for a principal decrease to be settled to an investor associated with the first principal amount.

17. The system of claim 16, wherein the one or more processors are further configured to execute one or more computer program modules configured to lend credit to the dealer to cover the principal decrease being settled to the investor.

18. The system of claim 17, wherein the credit is capped by a clearinghouse associated with the Tri-Party repurchasing agreement.

19. The system of claim 14, wherein the security information of the one or more securities are matched to the new investor to create a smallest possible principal difference between the first principal amount and the second principal amount as compared to a third principal amount associated with others of the plurality of securities associated with other Tri-Party repurchasing agreements.

20. The system of claim 11, wherein the one or more processors are further configured to execute one or more computer program modules configured to generate projected allocations of collateral in maturing Tri-Party Repurchasing agreements with new investors, and allow a user to selectively implement the projected allocations.
